(19) United States
(12) Patent Application Publication
(10) Pub. No.: US 2013/0119033 A1
(43) Pub. Date: May 16, 2013

(54) MOBILE WELDING SYSTEM AND METHOD

(71) Applicant: Geoffrey M. Lipnevicius, Sagamore Hills, OH (US)

(72) Inventor: Geoffrey M. Lipnevicius, Sagamore Hills, OH (US)

(73) Assignee: LINCOLN GLOBAL, INC., City of Industry, CA (US)

(21) Appl. No.: 13/294,539

(22) Filed: Nov. 11, 2011

(51) Int. Cl. B23K 9/10

(52) U.S. Cl. 219/130.1; 219/136; 219/137 R

(57) ABSTRACT

A mobile welding system has a mobile base for traversing a surface, proximate to a region to be welded. The mobile welding system has a lift, coupled to the mobile base and to a platform for moving the platform vertically proximate to the region. The lift is disposed between the platform and the mobile base. The mobile welding system has a robotic arm coupled to the platform. The mobile welding system has a welding torch, disposed on a first end of the robotic arm, for welding the region. The mobile welding system has a controller configured to cause the welding torch to move proximate to the region by causing at least one of the mobile base, the lift, and the robotic arm to move in at least one direction.

### FIELD OF INVENTION

The present disclosure relates to the field of welding. More particularly, the present disclosure relates to a mobile welding system and method.

### BACKGROUND

Welding is a technique used to join two metals together. A welding torch applies an electric current to the metals at a seam, or a region, in order to heat and melt the metals. As the metals cool, they combine to form a joint. The welding torch can be controlled and directed into proper position to perform the weld manually by an operator. Alternatively, a welding torch may be controlled by a robot, such as an Arc Mate® welding robot manufactured by Fanuc Robotics.

As the length of the seam or the region becomes large, controlling the welding torch to maintain proper position along the seam or region may become labor intensive for an operator. Controlling the welding torch to maintain proper position along the seam or region may become even more labor intensive for the operator when the seam or region is not easily accessible to the operator, at an extreme height, for example. Even with the aid of a robot, it may still be labor intensive for the operator since a robot may not be capable of performing welds over a large region, without operator assistance. Additionally, an operator may be prone to making welding errors when performing large welds since large welds may require intensive focus over an extended period of time.

### SUMMARY OF THE INVENTION

A mobile welding system has a mobile base for traversing a surface, proximate to a region to be welded. The mobile welding system has a lift, coupled to the mobile base and to a platform for moving the platform vertically proximate to the region. The lift is disposed between the platform and the mobile base. The mobile welding system has a robotic arm coupled to the platform. The mobile welding system has a welding torch, disposed on a first end of the robotic arm, for welding the region. The mobile welding system has a controller configured to cause the welding torch to move proximate to the region by causing at least one of the mobile base, the lift, and the robotic arm to move in at least one direction.

In a method for automatically moving a welding torch, a computer receives data representative of a region to be welded. The computer causes a robotic arm comprising a welding torch to move the welding torch proximate to the region, based on the data. The computer causes a lift, disposed between a platform coupled to the robotic arm and a mobile base, to move the platform vertically proximate to the region, based on the data. The computer causes the mobile base to traverse a surface proximate to the region, based on the data.

An apparatus for automatically moving a welding torch has a welding torch, disposed on a first end of a robotic arm, for welding a region. The robotic arm is coupled to a platform. The apparatus has a means for traversing the platform along a surface, proximate to the region. The apparatus has a means for raising and lowering the platform. The apparatus has a means for causing the welding torch to move along the region by causing at least one of the means for traversing the platform along a surface and the means for raising and lowering the platform to move the platform in at least one direction.

### BRIEF DESCRIPTION OF THE DRAWINGS

In the accompanying drawings, structures are illustrated that, together with the detailed description provided below, describe exemplary embodiments of the claimed invention. Like elements are identified with the same reference numerals. It should be understood that elements shown as a single component may be replaced with multiple components, and elements shown as multiple components may be replaced with a single component. The drawings are not to scale and the proportion of certain elements may be exaggerated for the purpose of illustration.

FIG. 1 illustrates an example mobile welding system.

FIG. 2 illustrates an example mobile welding system having a scissor lift.

FIG. 3 illustrates an example mobile welding system having a telescoping boom.

FIG. 4 is a flow chart illustrating an example method for automatically moving a welding torch.

FIG. 5 is a block diagram of an example computing device for controlling movement of an example mobile welding system.

### DETAILED DESCRIPTION

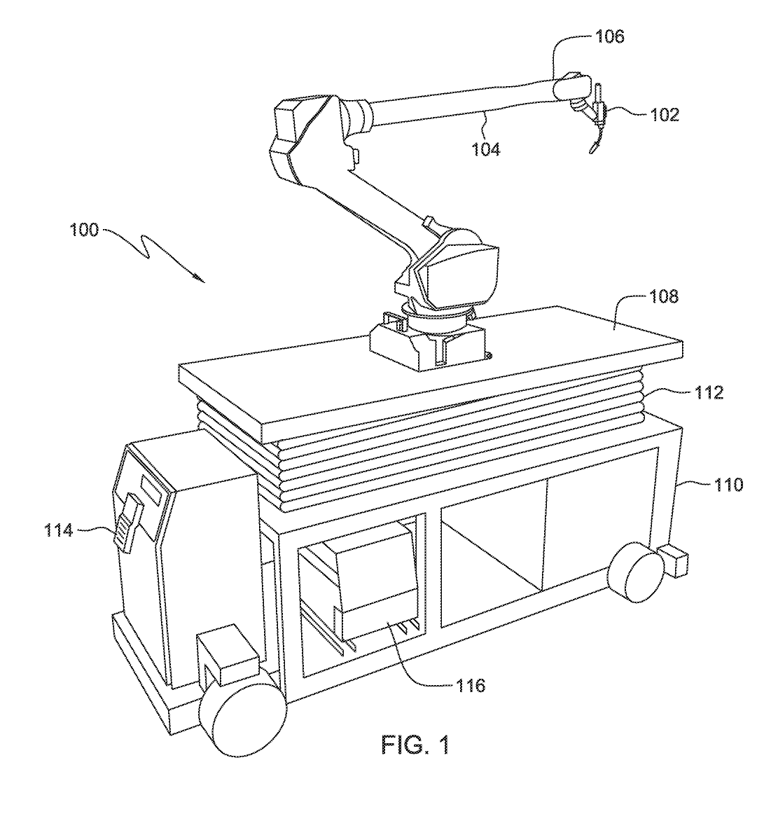

FIG. 1 illustrates an example mobile welding system 100. Mobile welding system 100 has a welding torch 102 for welding a region, or a seam between two metals. Welding torch 102 can be configured to perform an arc weld or other similar types of welds on a region to join two metals together.

Mobile welding system 100 has a robotic arm 104 capable of moving in three dimensions. Welding torch 102 is disposed on first end 106 of robotic arm 104. Thus, robotic arm 104 is capable of moving welding torch 102 proximate to the seam so that welding torch can weld the seam appropriately.

Mobile welding system 100 has a platform 108 for supporting robotic arm 106. Robotic arm 106 is secured to platform 108 to prevent robotic arm 106 from shifting while welding torch 102 is performing a weld. Platform 108 can be constructed of one or more known materials, such as wood or metal, for example.

Mobile welding system 100 has a mobile base 110 for moving substantially horizontally proximate o the region to be welded. Mobile base 110 may be configured to move freely on a surface. In other words, mobile base 110 may be configured to move in any horizontal direction along a surface, proximate to the region to be welded. Alternatively, mobile base 100 may be restricted to move horizontally along a predefined physical track (not shown). In other words, mobile base 100 may be restricted to move in a single horizontal line, proximate to the region to be welded.

In an example embodiment, mobile base 110 is an automated guided vehicle for moving substantially horizontally proximate to a region to be welded._Mobile base 110 may be configured to follow a predefined path as defined by one or more markers on or around a horizontal surface proximate to the region to be welded. For example, mobile base 110 may be configured to follow a line on a ground which runs alongside an object having a region to be welded. Alternatively, mobile base 110 may be configured with a sensor, such as a laser,for detecting a horizontal surface proximate to the region to be welded. In other words, mobile base 110 may be configured to move along a surface proximate to the region to be welded, based on information received from the sensor.

Platform 108 is coupled to mobile base 110. Thus, as a region to be welded extends for a long distance, welding torch 102, which is secured to platform 108 via robot arm 106, is able to continue to weld the region as mobile base 110 moves substantially horizontally proximate to the region to be welded, without interruption or operator intervention. This helps eliminate a labor intensive process of controlling a welding torch to maintain proper position along a region over a long distance.

Platform 108 is coupled to mobile base 110 via lift 112. In an example embodiment, lift 112 is a hydraulic lift. Lift 112 is configured to move platform 108 vertically, proximate to the region to be welded. Lift 112 is able to move platform 108, and in turn welding torch 102, up and down proximate to the region to be welded, in order for welding torch 102 to continue to weld the region as the region extends up and down. This helps eliminate a labor intensive process of controlling a welding torch to maintain proper position along a region when the region is not easily accessible to the operator, such as at an extreme height.

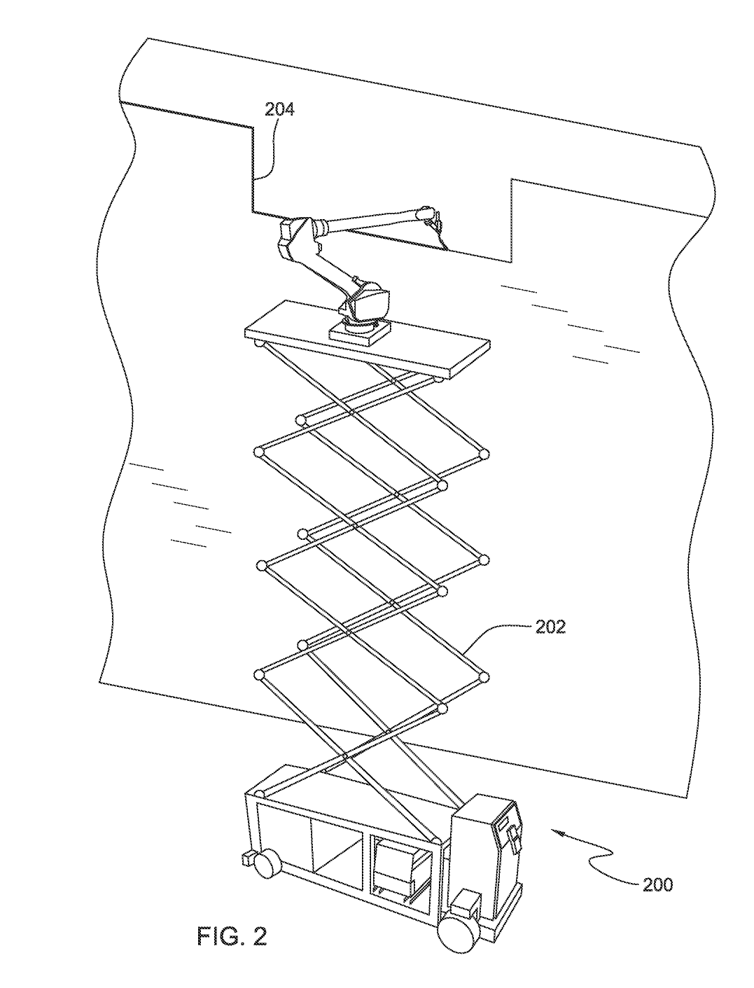

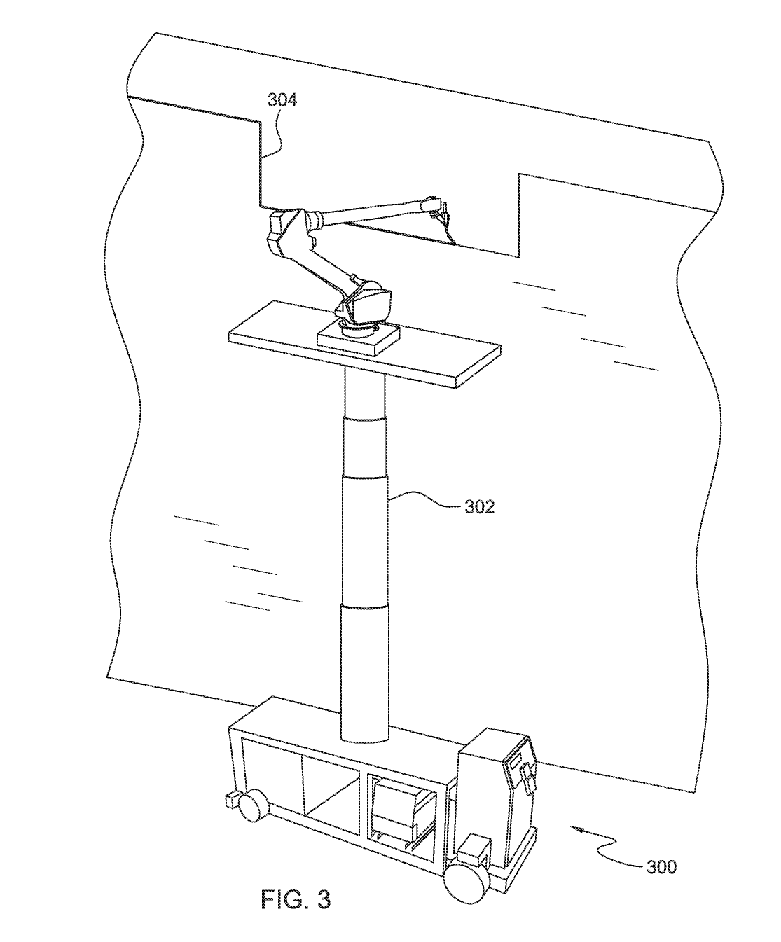

In an example embodiment, as illustrated in FIG. 2, mobile welding system 200 has a scissor lift 202 for moving a platform vertically, proximate to a region to be welded 204. In an alternative example embodiment, as illustrated in FIG. 3, mobile welding system 300 has a telescoping boom 302 for moving a platform vertically, proximate to a region to be welded 304.

It should be understood that although FIG. 2 and FIG. 3 illustrate a mobile welding system comprising a scissor and telescoping boom-type lifts, respectively, although other type lifts might be employed. The lift 112 of mobile welding system 100 described in FIG. 1 may comprise other forms or structures, capable of raising and lowering platform 108 proximate to a region to be welded.

Referring again to FIG. 1, mobile welding system 100 has a controller 114 for causing welding torch 102 to move proximate to the region by causing at least one of mobile base 110, lift 112, and robotic arm 104 to move in at least one direction. Controller 114 may be configured to move mobile base 110, lift 112, and robotic arm 104 according to predefined instructions. For example, an operator may provide controller 114 with a detailed set of instructions regarding the size and location of a region to be welded.

In an example embodiment, mobile welding system 100 has a sensor (not shown) on first end 106 of robotic arm 104, in communication with controller 114, for automatically detecting the region to be welded and for communicating data representative of the region to controller 114. The sensor can be an infrared camera or a laser camera, for example. Controller 114 may be configured to control mobile base 110, lift 112, and robotic arm 104 to move in at least one direction according to the received data representative of the region. In such an example, mobile welding system 100 would not require predefined instructions from an operator, instead being capable of adapting to the region to be welded in real-time.

It should be understood that although FIG. 1 depicts mobile welding system 100 as having a single controller 114 for controlling the movement of mobile base 110, lift 112, and robotic arm 104, mobile welding system 100 may have multiple controllers. For example, mobile welding system 100 may have three controllers (not shown); one for controlling the movement of mobile base 110, one for controlling the movement of lift 112, and one for controlling the movement of robotic arm 104. Controller 114 may be a microcontroller, a computer such a laptop or personal computer, a mobile computer such a tablet, or other computing device configured to cause mobile base 110, lift. 112, and robotic arm 104 to move accordingly.

Mobile welding system 100 has a power supply 116 for powering one or more of mobile base 110, lift 112, robotic arm 104, welding torch 102, and controller 114. Having an on-board power supply 116 enables mobile welding system 100 to move about, proximate to a region to be welded, without being restricted to staying near an electrical outlet or other stationary power source.

In an example embodiment, an operator may manually move mobile welding system 100 to a second region in order to begin to perform a second weld after mobile welding system 100 performs a weld on a first region. Alternatively, mobile welding system 100 may be configured to automatically move to a second region after completing a first weld at a first region, and to automatically begin to perform a second weld.

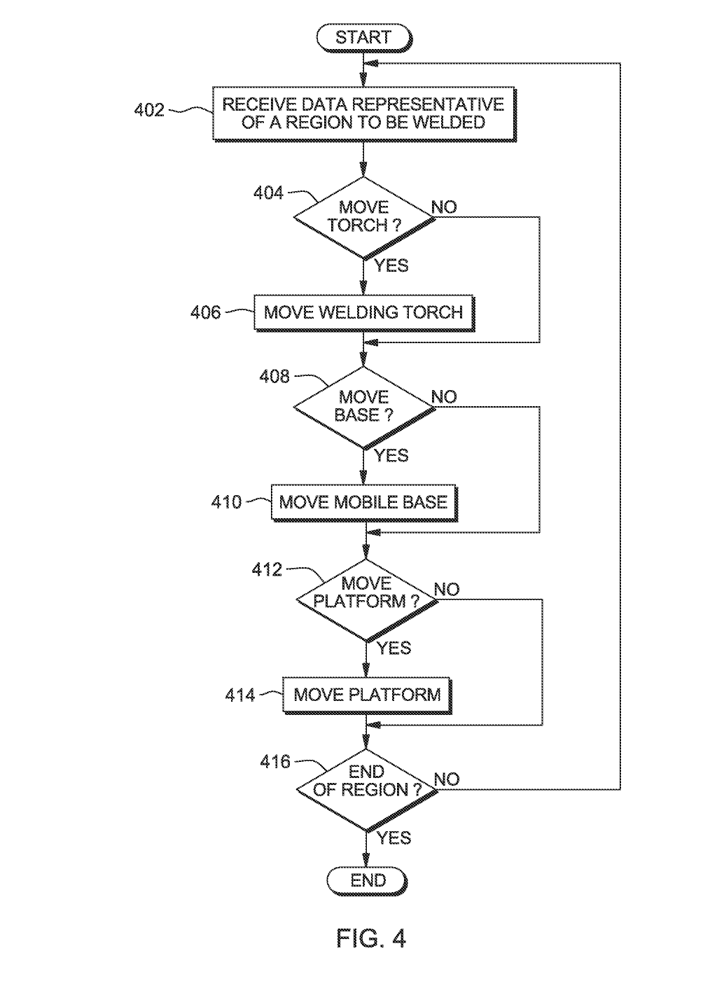

FIG. 4 is a flow chart illustrating an example method for automatically moving a welding torch. At step 402, controller 114 receives data representative of a region to be welded. In an example embodiment, controller 114 may receive the data from an internal database that was pre-loaded with information by an operator. For example, an operator may pre-define the location and dimensions of a region to be welded. The operator may also predefine the movement instructions necessary to properly position welding torch 102 to perform a weld. For example, a set of predefined instructions may include: 1) move right two feet; 2) move down one foot; 3) move right three feet; 4) move in a semi-circle with a radius of two feet; and 5) stop. Thus, controller 114 may initially receive data representative of the entire region to be welded before mobile welding torch 100 makes any movements. Alternatively, controller 114 may receive the data in real-time from one or more sensors. For example, controller 114 may not know about the dimensions or location of the region to be welded in advance. Instead, controller 114 may initially receive data representative of a portion of region to be welded. As a sensor acquires further data, controller 11.4 may then receive additional data as well.

At step 404, controller 114 determines whether the position of welding torch should be adjusted, based on the received data. If controller 114 determines that the position of welding torch 102 should be adjusted (decision 40.4, yes branch), then controller 114 causes robotic arm 104 to move the welding torch 102, at step 406, proximate to the region to be welded, based on the data.

At step 408, controller 114 determines whether the position of mobile base 110 should be adjusted, based on the received data. If controller 114 determines that the position of mobile base 110 should be adjusted (decision 408, yes branch), then controller 114 causes mobile base 110 to move substantially horizontally, at step 410, proximate to the region to be welded, based on the data.

At step 412, controller 114 determines whether the position of platform 108 should be adjusted, based on the received data. If controller 114 determines that the position of platform 108 should be adjusted (decision 412, yes branch), then controller 114 causes lift 112 to move platform 108 vertically, at step 414, proximate to the region to be welded, based on the data.

At step 416, controller 114 determines whether welding torch 102 has reached the end of the region to be welded. If controller 114 determines that welding torch 102 has not yet reached the end of the region to be welded (decision 416, no branch), than controller 114 repeats the steps of receiving data representative of the region to be welded and moving mobile welding robot 100 accordingly until the controller 114 determines that welding torch 102 has reached the end of the region to be welded (decision 416, yes branch).

It should be understood that the combination of the vertical mobility provided by lift 112 along with the horizontal mobility provided by mobile base 110 enables controller 114 to move welding torch 102 in a variety of directions, thus enabling welding torch 102 to track a variety of shapes of regions to be welded. For example, combining the appropriate vertical movement with the appropriate horizontal movement, in the appropriate directions, controller 114 is able to control welding torch 102 to follow a circular path, a linear path, a curved path, or a path of varying lines and angles.

It should be further understood that controller 114 may be capable of moving welding torch 102 proximate to a region to be welded in more than one way. For example, if data indicates that a region to be welded extends 1 foot to the right, controller may either cause robotic arm 104 to move welding torch 102 one foot to the right. Alternatively, controller 114 may not cause robotic arm 104 to move at all and instead cause mobile base 110 to move one foot to the right while robotic arm 104 remains motionless, relative to mobile welding system 100. Thus, in an example embodiment, controller 114 may be capable of determining whether to cause robotic arm 106, lift 112, or mobile base 110 to move, based on the data. For example, controller 114 may cause robotic arm 104 to move when the data suggests that a shorter, more precise movement is required while controller 114 may cause mobile base 110 or lift 112 to move when the data suggest that a longer, and possibly less precise, movement is required. The thresholds for distances and other general rules for determining how mobile robotic arm 100 moves may be predefined by an operator and stored in controller 114.

Although the steps of FIG. 4 have been described in a specific order, it should be understood that the steps may be performed out of order as For example, controller 114 may first cause lift 112 to move platform 108 before causing robotic arm 104 to move welding torch 102.

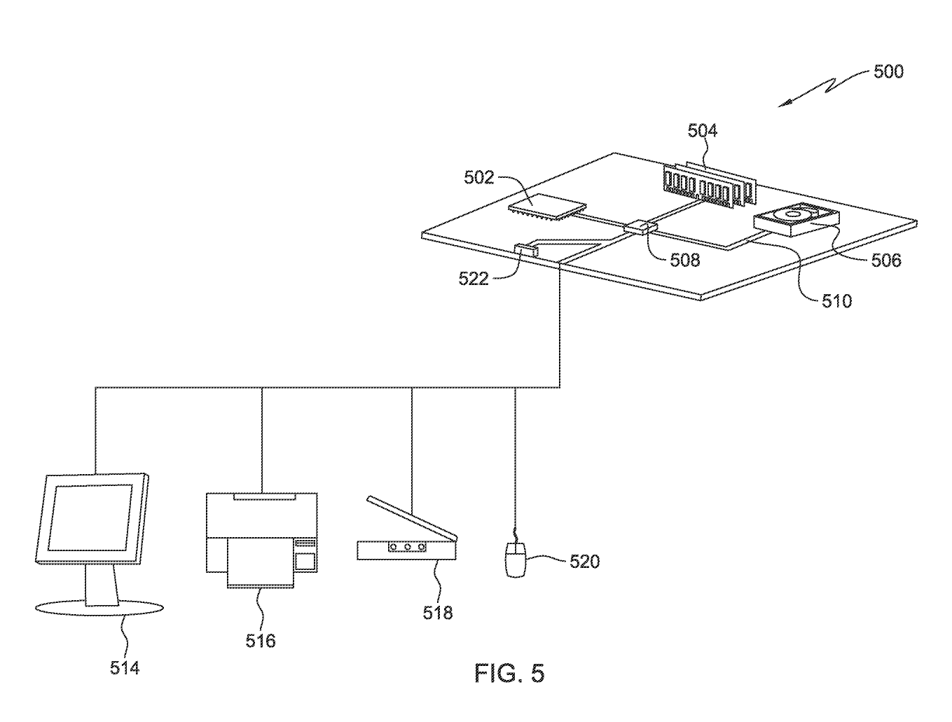

FIG. 5 is a block diagram of an example computer system 500 for controlling movement of an example mobile welding system. Computer system 500 is intended to represent various forms of digital computers, including laptops, desktops, handheld computers, tablet computers, servers, and other similar types of computing devices. Computer system 500 includes a processor 502, memory 504, a storage device 506, and a communication port 522, connected by an interface 508 via a bus 510.

Storage device 506 may store program instructions configured to cause mobile base 110, lift 112 and robotic arm 104 to move.

Processor 502 processes instructions, via memory 504, for execution within computer system 500. In an example embodiment, multiple processors along with multiple memories may be used. In an example embodiment, multiple computer systems 400 may be connected, with each device providing portions of the necessary operations.

Memory 504 may be volatile memory or non-volatile memory. Memory 504 may be a computer-readable medium, such as a magnetic disk or optical disk. Storage device 506 may be a computer-readable medium, such as floppy disk devices, a hard disk device, and optical disk device, a tape device, a flash memory, or other similar solid state memory device, or an array of devices, including devices in a storage area network of other configurations. A computer program product can be tangibly embodied in a computer readable medium such as memory 504 or storage device 506. The computer program product may contain program instructions configured to cause mobile base 110, lift 112 and robotic aim 104 to move.

Computer system 500 can be coupled to one or more input and output devices such as a display 514, a scanner 518, a printer 516, and a mouse 520.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995). Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or components.

Some portions of the detailed descriptions are presented in terms of algorithms and symbolic representations of operations on data bits within a memory. These algorithmic descriptions and representations are the means used by those skilled in the art to convey the substance of their work to others. An algorithm is here, and generally, conceived to be a sequence of operations that produce a result. The operations may include physical manipulations of physical quantities. Usually, though not necessarily, the physical quantities take the form of electrical or magnetic signals capable of being stored, transferred, combined, compared, and otherwise manipulated in a logic and the like.

It has proven convenient at times, principally for reasons of common usage, to refer to these signals as bits, values, elements, symbols, characters, terms, numbers, or the like. It should be borne in mind, however, that these and similar terms are to be associated with the appropriate physical quantities and are merely convenient labels applied to these quantities. Unless specifically stated otherwise, it is appreciated that throughout the description, terms like processing, computing, calculating, determining, displaying, or the like, refer to actions and processes of a computer system, logic, processor, or similar electronic device that manipulates and transforms data represented as physical (electronic) quantities.

While the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the application, in its broader aspects, is not limited to the specific details, the representative apparatus and method, and illustrative examples shown and described. Accordingly, departures may be made from such details without departing from the spirit or scope of the applicant's general inventive concept.

What is claimed is:

1. A mobile welding system comprising:
a mobile base for traversing a surface, proximate to a region to be welded;
a lift coupled to the mobile base and to a platform for moving the platform vertically proximate to the region, the lift disposed between the platform and the mobile base;
a robotic arm coupled to the platform;
a welding torch, disposed on a first end of the robotic arm, for welding the region; and
a controller configured to cause the welding torch to move proximate to the region by causing at least one of the mobile base, the lift, and the robotic arm to move in at least one direction.

2. The mobile welding system of claim 1, wherein the lift comprises a scissor lift.

3. The mobile welding system of claim 1, wherein the mobile base comprises an automated guided vehicle for automatically traversing a surface proximate to a region to be welded.

4. The mobile welding system of claim 1, further comprising a power supply for powering at least one of the mobile base, the lift, the robotic arm, the welding torch, and the controller.

5. The mobile welding system of claim 1, wherein the controller configured to cause the welding torch to move proximate to the region, is configured to cause at least one of the mobile base, the lift, and the robotic arm to move in at least one direction according to at least one predefined instruction.

6. The mobile welding system of claim 1, further comprising a sensor in communication with the controller, disposed on the first end of the robotic arm, for automatically detecting the region and for communicating data representative of the region to the controller, wherein the controller is configured to cause the welding torch to move proximate to the region, is configured to cause at least one of the mobile base, the lift, and the robotic arm to move in at least one direction according to the received data representative of the region.

7. The mobile welding system of claim 6, wherein the sensor comprises one of an infrared camera and a laser camera.

8. A method for automatically moving a welding torch, comprising the steps of:
a computer receiving data representative of a region to be welded;
the computer causing a robotic arm comprising a welding torch to move the welding torch proximate to the region, based on the data;
the computer causing a lift; disposed between a platform coupled to the robotic arm and a mobile base, to move the platform vertically proximate to the region, based on the data; and
the computer causing the mobile base to traverse a surface proximate to the region; based on the data.

9. The method of claim 8, wherein the step of the computer causing a lift, disposed between the platform and the mobile base, to move the platform vertically, comprises the computer causing a scissor lift, disposed between the platform and the mobile base, to move the platform vertically.

10. The method of claim 8, wherein the step of the computer causing a mobile base to traverse a surface proximate to the region, comprises the computer causing an automated guided vehicle, to automatically traverse a surface proximate to the region.

11. The method of claim 8, wherein the step of the computer receiving data representative of a region to be welded by a welding torch, comprises the computer receiving predefined data, representative of the region.

12. The method of claim 8, wherein the step of the computer receiving data representative of a region to be welded by a welding torch, comprises the computer receiving, from a sensor, real-time data representative of the region.

13. The method of claim 12, wherein the step of the computer receiving, from a sensor, real-time data, comprises the computer receiving, from one of an infrared camera and a laser camera, real-time data representative of the region.

14. The method of claim 8, wherein the computer causes the lift to move the platform vertically simultaneous to the computer causing the mobile base to traverse the surface, and wherein the combined movement of the lift and the mobile base causes the welding torch to move non-linearly.

15. The method of claim 14, wherein the combined movement of the lift and the mobile base cause the welding torch to move in a curved path.

16. The method of claim 8, further comprising the steps of:
the computer determining that the welding torch has reached the end of the region;
the computer receiving data representative of a second region to be welded by the welding torch;
the computer causing the robotic arm comprising the welding torch to move along the second region, based on the data representative of the second region;
the computer causing the mobile base, comprising the platform coupled to the robotic arm, to move along the surface proximate to the second region, based on the data representative of the second; and
the computer causing the lift, disposed between the platform and the mobile base, to raise or lower the platform, based on the data representative of the second region.

17. An apparatus for automatically moving a welding torch comprising:
a welding torch, disposed on a first end of a robotic arm, for welding a region, the robotic arm coupled to a platform;
a means for traversing the platform along a surface, proximate to the region;
a means for raising and lowering the platform;
a means for causing the welding torch to move along the region by causing at least one of the means for traversing the platform along a surface and the means for raising and lowering the platform to move the platform in at least one corresponding direction.

18. The apparatus of claim 17, further comprising a means for powering the welding torch.

19. The apparatus of claim 17, wherein the means for causing the welding torch to move along the region, causes at least one of the means for traversing the platform along a surface and the means for raising and lowering the platform to move the platform in at least one direction according to at least one predefined instruction.

20. The apparatus of claim 17, further comprising a means for automatically detecting the region and for communicating data representative of the region to the means for causing the welding torch to move along the region, wherein the means for causing the welding torch to move along the region causes at least one of the means for traversing the platform along a surface and the means for raising and lowering the platform to move the platform in at least one direction according to the received data representative of the region.
